(19) United States
(12) Patent Application Publication
(10) Pub. No.: US 2018/0122161 A1
(43) Pub. Date: May 3, 2018

(54) Combination model vehicle commercial off the shelf performance characteristics system

(71) Applicant: Ross Bolton, Santa Fe, NM (US)

(72) Inventor: Ross Bolton, Santa Fe, NM (US)

(21) Appl. No.: 15/342,960

(22) Filed: Nov. 3, 2016

(51) Int. Cl. G07C 5/00; G07C 5/04; A63H 19/22

(52) U.S. Cl. CPC G07C 5/008; A63H 19/22; G07C 5/04

(57) ABSTRACT

The present invention provides a system and method for calculating the performance characteristics in a model vehicle system at many locations of vehicle usage. One embodiment of the present invention operates in accordance with a model train that includes a commercial off the shelf (COTS) calculating computer receiving information from an axle rotation sensing device, sufficient to calculate or record in actual or scale units performance characteristics such as speed, distance, time in motion, averages, maximums and minimums, energy used, comparison to averages, temperature, lap counts, etc.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

### 1. Field of the Invention

The present invention relates to model vehicle systems, or more particularly, to a system and method for calculating performance characteristics in a model train system, including at least one model train.

### 2. Description of Related Art

It is known in the art for model vehicles, such as model trains, to desire to know the actual or scale performance characteristics of the vehicle, in order to match the speeds of vehicles or for other purposes or interests. Some performance characteristic devices are fixed along the track so that they can tell the model vehicle characteristics, such as speed, at that single point only. When performance characteristic systems are attached to the model vehicle, some require complicated electronic circuits that are costly enough to restrict the performance characteristic systems to only a few train cars, such as the engine. Others require limited pivoting motion of the truck to prevent failure of the performance characteristic system, which therefore restricts the performance characteristic system to train cars with centrally placed wheel sets like engines, or with truck bases that pivot very little. Other performance characteristic systems may incorporate a device on the wheel, increasing risk of interacting adversely with debris or the model system itself.

Thus, it would be advantageous to provide a model vehicle system and method that overcomes at least some of the foregoing drawbacks. For example, such a system should be able to tell the performance characteristics at many instances. Such a system should use commercial off the shelf (COTS) calculating computers to keep the cost inexpensive so as to be able to incorporate the system in a greater range of model vehicles. It would also be advantageous to incorporate devices on the truck so as to allow greater range of truck pivoting motion without system failure. It would also be advantageous to avoid the wheel when incorporating performance characteristic system devices to reduce the possibility of interacting adversely with debris or the model system itself.

### BRIEF SUMMARY OF INVENTION

The present invention provides a system and method for calculating the performance characteristics in a model vehicle system at many locations of vehicle usage. One embodiment of the present invention operates in accordance with a model train that includes a commercial off the shelf (COTS) calculating computer receiving information from an axle rotation sensing device, sufficient to calculate or record in actual or scale units performance characteristics such as speed, distance, time in motion, averages, maximums and minimums, energy used, comparison to averages, temperature, lap counts, etc. Such use of COTS equipment keeps the cost inexpensive so as to be able to incorporate the system in a greater range of model vehicles and be a viably priced product in the marketplace.

In one example embodiment of the model vehicle performance characteristics system, the model vehicle includes an axle rotation sensing device on the truck, and an axle rotation conveyance device on the axle. Thus, the axle rotation conveyance device conveys axle rotation to the axle rotation sensing device, then the axle rotation sensing device conveys the axle rotation to the COTS calculating computer, which then calculates the performance characteristics of the model vehicle. This configuration allows for installation on model vehicles whose trucks pivot greatly without system failure, such as those with wheel sets at the end of the model vehicle (flat car, caboose, tanker, etc.) as compared to being restricted to only models with wheel sets located near the middle of the model vehicle (engine, etc.).

By way of another example embodiment, the model vehicle axle has attached magnetic material as the axle rotation conveyance device to convey axle rotation to a reed switch axle rotation sensing device on the vehicle truck. The reed switch rotation sensing device conveys the axle rotation to the COTS calculating computer which then calculates the performance characteristics of the model vehicle. The positioning of such devices on the axle and truck reduces the possibility of interacting adversely with debris or the model system (track switches, model layout features, etc.).

It should also be appreciated that the described embodiments are not limited to any particular method of axle rotation conveyance devices or axle rotation sensing devices. For example, the axle can have attached or incorporated a protrusion, void, change in reflectivity, magnetic strength, or other differentiation or differentiations so that a proximity, optical, reed, or other axle rotation sensing device can sense the axle rotation or partial rotation. The COTS calculating computers come with or recommend compatible rotation conveyance and rotation sensing devices, and the attachment of said devices, their equivalents or improvements, to the model vehicle would also fall within the scope and spirit of the present invention.

By way of another example, the COTS calculating computer is a physical bicycle COTS calculating computer attached to the model vehicle for viewing while in motion. It should also be appreciated that the present invention is not limited to any particular COTS calculating computer. The COTS calculating computers have various physical attributes such lighting, display sizes, environmental durability, etc., and such attributes would also fall within the scope and spirit of the present invention.

By way of another example, the COTS calculating computer is a software COTS calculation computer. The software COTS calculation computer is a software program or software application or app incorporated into a device to run such software. It should also be appreciated that the present invention is not limited to any particular software program or device to run the software. Such a software COTS calculation computer may be incorporated into a smart phone, tablet, laptop, watch, personal computer, internet of things device, or other device that can receive the axle rotation information from the axle rotation sensing device and perform the calculations required to convey performance characteristics of the model vehicle.

It should also be appreciated that the present invention is not limited to providing any particular model vehicle performance characteristic. COTS calculating computers may provide various model vehicle performance characteristic functions including speedometer, odometer, lap counting, maximums and minimums, averages, temperature, fuel consumption displayed in calories or the like, current speed in comparison to average speed, total time in motion, time in motion since last reset, clock, timer, etc., and derivative alerts such as when to maintain model vehicle components or maintain objects in the model system such as the train track. Such performance characteristics would also fall within the scope and spirit of the present invention.

In another embodiment of the present invention, the axle rotation sensing device conveys the axle rotation to a transmitter attached to the model vehicle. Thus, the axle rotation is conveyed to the transmitter, the transmitter then conveys the axle rotation to the COTS calculating computer, which then calculates the performance characteristics of the model vehicle. This configuration allows for the COTS calculating computer to be off of the model vehicle so that the performance characteristics may be conveyed to the operator without the operator having to follow the model vehicle to view such characteristics.

In another embodiment of the invention, the axle rotation sensing device is an accelerometer, gyroscope, global positioning system (GPS) module, or the like, attached to the model vehicle axle. Also attached to the axle is a transmitter, such that the axle rotation is conveyed by the axle rotation sensing device to the transmitter, the transmitter then conveys the axle rotation to the COTS calculating computer attached to or separate from the model vehicle, and the COTS calculating computer then calculates the performance characteristics of the model vehicle.

A more complete understanding of a system and method for calculating performance characteristics in a model vehicle system will be afforded to those skilled in the art, as well as a realization of additional advantages and objects thereof, by a consideration of the following detailed description of the embodiments.

### BRIEF DESCRIPTION OF THE DRAWINGS

### Drawings—Figures

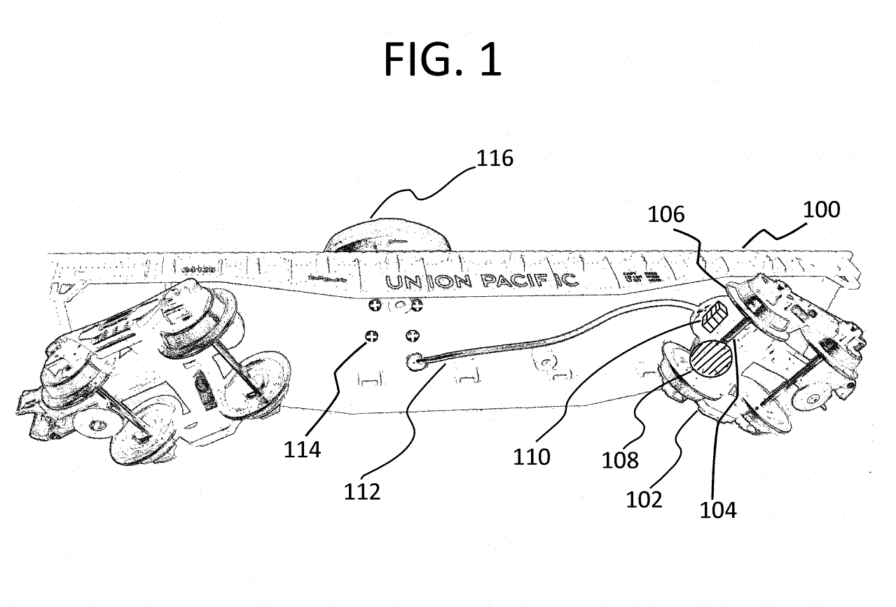

FIG. 1 illustrates the below view of a model vehicle performance characteristics system.

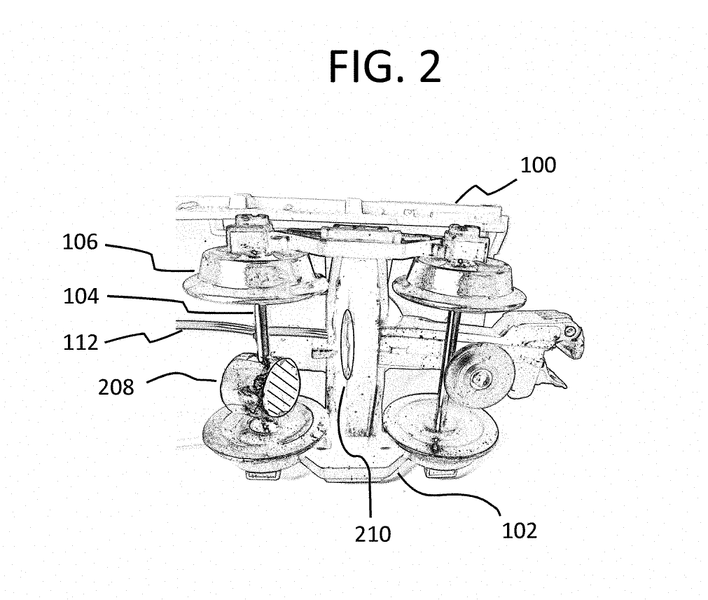

FIG. 2 illustrates the below view of a truck of a model vehicle performance characteristics system, where the axle rotation conveyance device is magnetic material and the axle rotation sensing device is a reed switch.

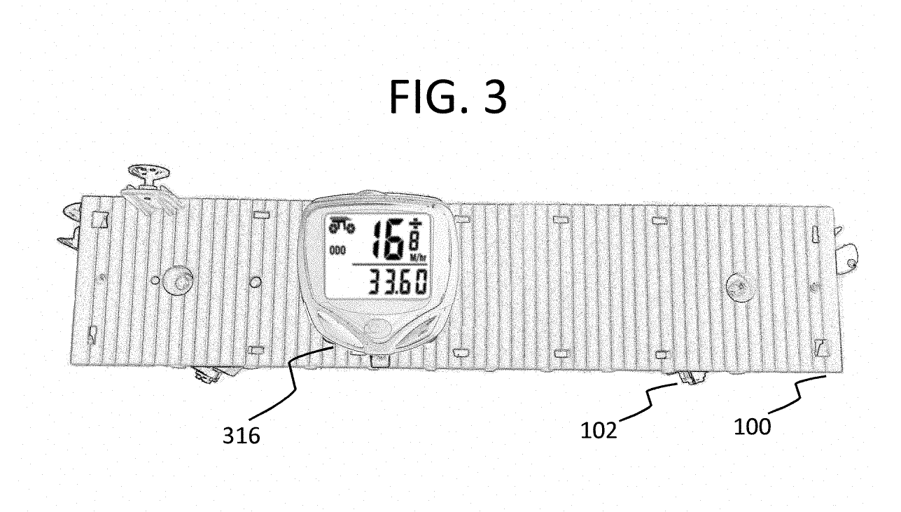

FIG. 3 illustrates the top view of a model vehicle performance characteristics system, where the COTS calculating computer is a physical computer whose primary purpose is to provide performance characteristics of bicycles.

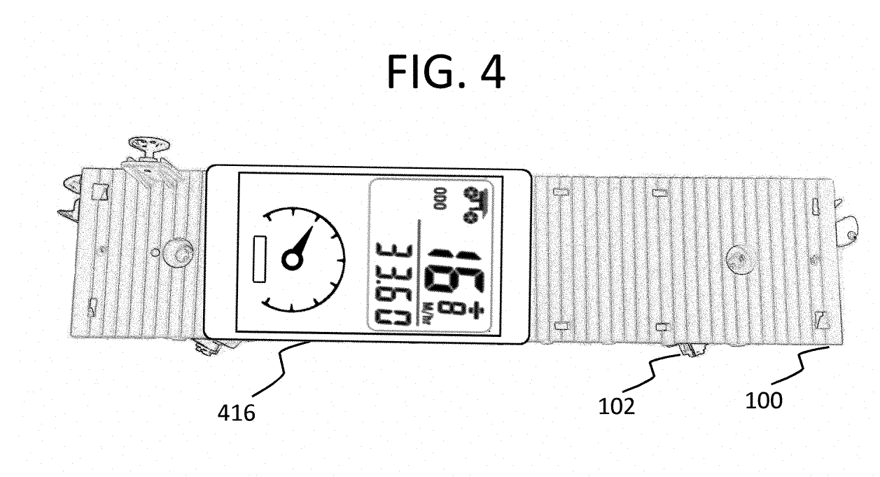

FIG. 4 illustrates the top view of a model vehicle performance characteristics system, where the COTS calculating computer is a software program.

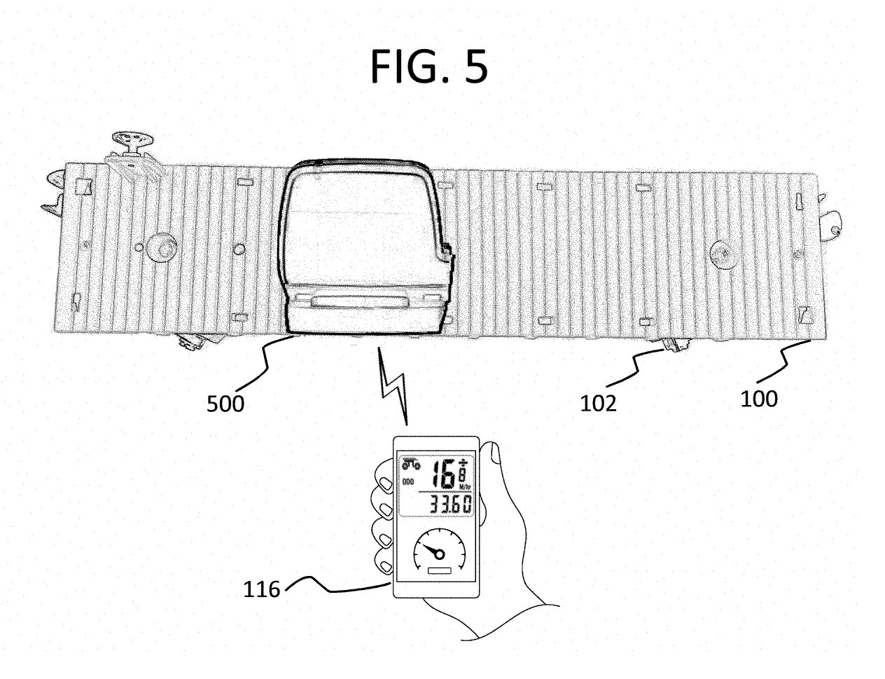

FIG. 5 illustrates the top view of a model vehicle performance characteristics system, where a transmitter on the model vehicle conveys the axle rotation to a COTS calculating computer off of the model vehicle.

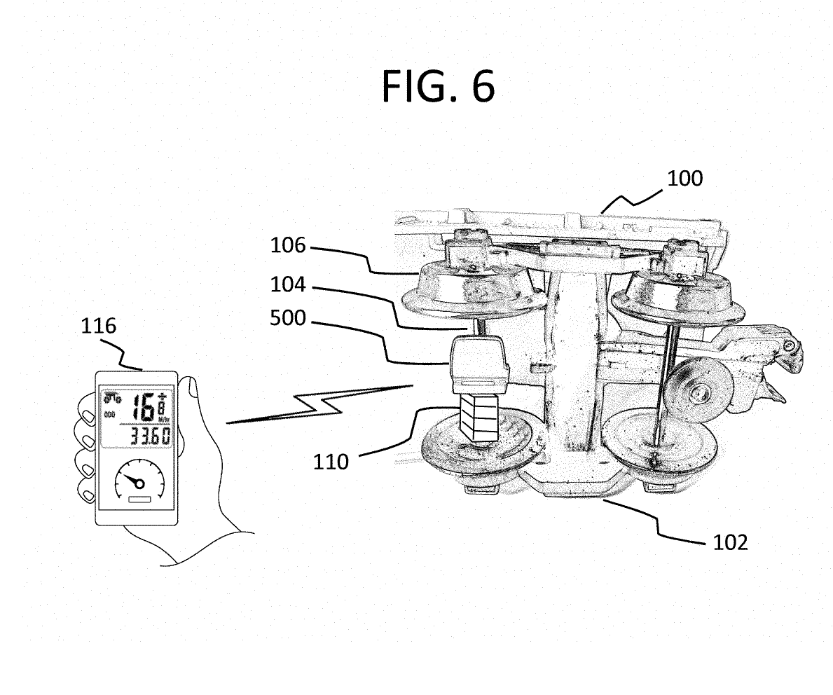

FIG. 6 illustrates the below view of a truck of a model vehicle performance characteristics system, where an axle rotation sensing device and transmitter are attached to the axle, conveying axle rotation information to a COTS calculating computer shown separate from the model vehicle.

### DRAWINGS—REFERENCE NUMERALS

| | |
|---|---|
| 100 | model vehicle |
| 102 | truck |
| 104 | axle |
| 106 | wheel set |
| 108 | axle rotation conveyance device |
| 110 | axle rotation sensing device |
| 112 | wire |
| 114 | screws |
| 116 | COTS calculating computer |
| 208 | magnet material axle rotation conveyance device |
| 210 | reed switch axle rotation sensing device |
| 316 | physical bicycle COTS calculating computer |
| 416 | software COTS calculating computer |
| 500 | transmitter |

### DETAILED DESCRIPTION

The present invention provides a system and method for calculating performance characteristics in a model vehicle system at many locations of the model vehicle usage. In the detailed description that follows, like element numerals are used to describe like elements illustrated in one or more figures.

FIG. 1 depicts one embodiment of a model vehicle performance characteristic system. The model vehicle 100 has joined to it truck 102 with wheel set 106 joined together by axle 104. Such model vehicles are purchased freely in the market in various materials, sizes, and joining methods.

Attached to the axle is axle rotation conveyance device 108 and attached to the truck is axle rotation sensing device 110. The axle rotation sensing device is connected by wire 112 to the COTS calculating computer 116. The COTS calculating computer is attached to the model vehicle by screws 114.

The axle rotation conveyance device may be attached to, fixed in position by, or made part of the axle via any non-tape means such as adhesive, shrink wrap, hot glue, epoxy, clamps, tie wraps, set screws, etc. Or the axle rotation conveyance device may be attached to, or fixed in position by, a mounting object such as a cradle, housing, case, bracket, etc., which results in the axle rotation conveyance device being attached to, fixed in position by, or is made part of the axle, where the axle rotation conveyance device and mounting object are attached to the axle via a non-tape means. Tape means, which are excluded from this invention as the majority method to affix the axle rotation conveyance device to the axle, are adhesive affixed strips of material which are commonly known as electrical tape, packing tape, surgical tape, etc.

The axle rotation sensing device may be attached to, in, or on any part of the truck as is convenient and functional, including the top, side, rear, middle, etc.

The wire may be routed in various directions or lengths, as would be convenient for assembly and model vehicle use without interference to the model vehicle operation. As one example, instead of being routed as shown, the wire may be routed near or through the pivoting center of the truck.

To operate, the model vehicle in FIG. 1 is placed with the wheel set upon the roadbed or tracks (not shown). The wheel set, axle, and axle rotation conveyance device rotate as the model vehicle moves. The axle rotation conveyance device causes the axle rotation sensing device to change the electrical parameters (voltage, resistance, etc.) in the wire monitored by the COTS calculating computer such that the performance characteristics of the model vehicle may be calculated by the COTS calculating computer.

FIG. 2 depicts another embodiment. The axle 104, of model vehicle 100, incorporates magnetic material axle rotation conveyance device 208 to convey axle rotation to reed switch axle rotation sensing device 210. The reed switch axle rotation sensing device conveys the axle rotation by opening and closing the electrical circuit via wire 112 to the COTS calculating computer (not shown) such that the performance characteristics of the model vehicle may be calculated by the COTS calculating computer.

FIG. 3 depicts another embodiment where model vehicle 100 has attached to it a physical bicycle COTS calculating computer 316. This example orientation enables the operator to view and interact with the calculating computer from above. In operation, the physical bicycle COTS calculating computer detects from the wire (not shown) the electrical parameters that describe the rotation of the axle from the axle rotation sensing device (not shown) attached to truck 102, allowing the physical bicycle COTS calculating computer to calculate the performance characteristics of the model vehicle.

FIG. 4 depicts another embodiment where model vehicle 100 has attached to it a software COTS calculating computer 416. This example orientation enables the operator to view and interact with the calculating computer from above. In operation, the software COTS calculating computer detects from the wire (not shown) the electrical parameters that describe the rotation of the axle from the axle rotation sensing device (not shown) attached to truck 102, allowing the software COTS calculating computer to calculate the performance characteristics of the model vehicle.

FIG. 5 depicts another embodiment where model vehicle 100 has attached to it transmitter 500 that conveys axle rotation description to COTS calculating computer 116. This example orientation enables the operator to view and interact with the calculating computer detached from the model vehicle. In operation, the transmitter detects from the wire (not shown) the electrical parameters that describe the rotation of the axle from the axle rotation sensing device (not shown) attached to truck 102. The transmitter then conveys the axle rotation wirelessly to the COTS calculating computer, allowing the COTS calculating computer to calculate the performance characteristics of the model vehicle. The wireless transmission may be 802.11, Bluetooth, or as is able by the COTS calculating computer and transmitter.

FIG. 6 depicts another embodiment. The axle 104, attached to truck 102 of model vehicle 100, has attached to it axle rotation sensing device 110 and transmitter 500. The axle rotation sensing device describes the axle rotation to the transmitter. The transmitter then conveys the axle rotation wirelessly to COTS calculating computer 116, allowing the COTS calculating computer to calculate the performance characteristics of the model vehicle.

COTS calculating computers have axle sensing and conveyance devices compatible with their operation. One COTS calculating computer may be compatible with and potentially use a reed switch with a single piece or multiple pieces of magnetic material as implied in FIG. 2. Another COTS calculating computer may be compatible with and potentially use an accelerometer, gyroscope, or the like as implied in FIG. 6. These compatible devices, replacements, and or improvements, fall within the scope and spirit of the present invention.

The COTS calculating computer and or transmitter may be attached to the model vehicle by various means. They may be attached by adhesive, tie wraps, rivets, flexible locks, etc., or may be attached to the model vehicle by coupling with a cradle where the cradle itself is attached to the model vehicle.

It should be appreciated that the attachment positioning of the COTS calculating computer or transmitter, when attached, may change as is convenient, such as attached to the model vehicle body above, below, or to the side, or fixed within the model vehicle body, or be moveable, or be attachable to a fixed or movable cradle.

The COTS calculating computer and or transmitter may be of various sizes, shapes, environmental durability ratings, display capabilities, or offer other features or performance characteristics that are desirable to model vehicle operators.

The COTS calculating computer may be correlated to the full or partial rotation of the axle, or correlated to various model scales, such that the COTS calculating computer informs the operator of the desired actual or scale performance characteristics of the model vehicle. As a singular case example, to calibrate to an actual performance characteristic, such as actual speed during speedometer use or actual distance during odometer use, the operator would input the actual model train wheel circumference into the COTS calculating computer as the wheel circumference. As another singular case example, to calibrate to 1:48 O scale, for scale speed during speedometer use or scale distance during odometer use, the operator would input the actual model train wheel circumference multiplied by 48, the O scale, into the calculating computer as the wheel circumference. As is obvious to one in the art, this method can be used for other calculating computers required inputs, such as using wheel diameter instead, or the circumference of the representative wheel size before being reduced to model size, or in different units such as inch or millimeter, etc., and for other model train scales or wheel sizes in scales such as G, HO, etc.

Having thus described several embodiments of a system and method for calculating actual or scale performance characteristics in a model train system, it should be apparent to those skilled in the art that certain advantages of the system and method have been achieved. It should also be appreciated that various modifications, adaptations, and alternative embodiments thereof may be made within the scope and spirit of the present invention. The invention is solely defined by the following claims.

1. A model vehicle performance characteristics system, comprising:
a. a model vehicle,
b. a commercial off the shelf calculating computer attached to said model vehicle,
c. a truck attached to said model vehicle,
d. an axle with wheel set attached to said truck,
e. a means for conveying axle rotation is attached via a non-tape means to said axle,
f. a means for sensing axle rotation is attached to said truck,
g. said means for conveying axle rotation conveys the axle rotation to said means for sensing axle rotation,
h. said means for sensing axle rotation conveys the axle rotation to said commercial off the shelf calculating computer,
whereby said commercial off the shelf calculating computer will provide performance characteristics of said model vehicle.

2. The model vehicle of claim 1, wherein the means for conveying axle rotation is magnetic material.

3. The model vehicle of claim 1, wherein the means for sensing axle rotation is a reed switch.

4. The model vehicle of claim 1, wherein the commercial off the shelf calculating computer is a physical computer whose primary purpose is to provide performance characteristics of bicycles.

5. The model vehicle of claim 1, wherein the commercial off the shelf calculating computer is a software program.

6. A model vehicle performance characteristics system, comprising:
a. a model vehicle,
b. a commercial off the shelf calculating computer,
c. a transmitter attached to said model vehicle,
d. a truck attached to said model vehicle,
e. an axle with wheel set attached to said truck,
f. a means for conveying axle rotation is attached via a non-tape means to said axle,
g. a means for sensing axle rotation is attached to said truck,
h. said means for conveying axle rotation conveys the axle rotation to said means for sensing axle rotation,
i. said means for sensing axle rotation conveys the axle rotation to said transmitter,
j. said transmitter conveys the axle rotation to said commercial off the shelf calculating computer, whereby said commercial off the shelf calculating computer will provide performance characteristics of said model vehicle.

7. The model vehicle of claim 6, wherein the means for conveying axle rotation is magnetic material.

8. The model vehicle of claim 6, wherein the means for sensing axle rotation is a reed switch.

9. The model vehicle of claim 6, wherein the commercial off the shelf calculating computer is a physical computer whose primary purpose is to provide performance characteristics of bicycles.

10. The model vehicle of claim 6, wherein the commercial off the shelf calculating computer is a software program.

11. A model vehicle performance characteristics system, comprising:
a. a model vehicle,
b. a commercial off the shelf calculating computer,
c. an axle with wheel set attached to said model vehicle,
d. a means for sensing axle rotation is attached to said axle,
e. a transmitter is attached to said axle,
f. said means for sensing axle rotation conveys the axle rotation to said transmitter,
g. said transmitter conveys the axle rotation to said commercial off the shelf calculating computer, whereby said commercial off the shelf calculating computer will provide performance characteristics of said model vehicle.

12. The model vehicle of claim 11, wherein the means for sensing axle rotation is an accelerometer.

13. The model vehicle of claim 11, wherein the means for sensing axle rotation is a gyroscope.

14. The model vehicle of claim 11, wherein the commercial off the shelf calculating computer is a physical computer whose primary purpose is to provide performance characteristics of bicycles.

15. The model vehicle of claim 11, wherein the commercial off the shelf calculating computer is a software program.
